(19) United States
(12) Patent Application Publication
(10) Pub. No.: US 2006/0009271 A1
(43) Pub. Date: Jan. 12, 2006

(54) Virtual target getting game system

(75) Inventors: Toru Kamada, Kawasaki (JP); Yasuyuki Nakata, Kawasaki (JP); Kouichi Oikawa, Kawasaki (JP); Hisayoshi Ikeda, Kawasaki (JP); Makoto Sasaki, Kanagawa (JP); Masafumi Nishibata, Kanagawa (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); SANRIO COMPANY, LTD, Tokyo (JP)

(21) Appl. No.: 11/177,314

(22) Filed: Jul. 11, 2005

(30) Foreign Application Priority Data
Jul. 12, 2004 (JP) 2004-205032

(51) Int. Cl. A63F 13/00

(52) U.S. Cl. 463/1

(57) ABSTRACT

A player has an insect net to which a RF tag is attached and brings the RF tag close to a RF reader/writer mounted on a main game machine. A game controlling device records information about virtual insects that were spuriously gotten by the player through a RF reader/writer. To finish the game, the player brings the RF tag of the insect net close to a RF reader/writer of a result generating device. The result generating device reads player's information and the information about the virtual insects gotten by the player and output the result to a display or a printer.

### BACKGROUND OF THE INVENTION

The present invention relates to a game system in which players compete to get virtual targets, and more particularly, it relates to a game system that requires an actual action associated with the getting of a player.

A conventional target-getting game machine is disclosed in Japanese unexamined patent publication No. 2000-126441, for example. In the game machine disclosed in the publication, a player operates a crane hung from a ceiling of the machine in a horizontal direction and a vertical direction to pick up a target (a premium) stocked in a storage space.

However, since a managing side must prepare actual premiums and bring in new premiums when premiums were picked up by players and/or premiums were damaged in the game machine disclosed in the patent publication, the running cost becomes expensive.

On the other hand, a premium-getting video game in which a player can get a virtual premium in a game screen has a running-cost advantage because actual premiums are not needed to prepare. However, in such a video game, since a player operates an operation panel of the game machine even when the player gets a premium, the operation is different from an actual operation to get an actual premium, which is insufficient for the player due to lack of realistic sensation.

### SUMMARY OF THE INVENTION

It is therefore an object of the present invention to provide a virtual target getting game system, which is capable of reducing running cost and giving a player sufficient realistic sensation with an actual action for getting a target while it is virtual experience.

For the above object, according to a first aspect of the present invention, there is provided a virtual target getting game system, which includes: a target-getting tool to which a RF tag is attached; a main game machine in which RF reader/writers are mounted at positions of virtual targets to be gotten; a game controlling device that controls a RF reader/writer to record information about a virtual target assigned thereto into a RF tag when a player brings the RF tag attached to the target-getting tool close to the RF reader/writer to spuriously get the virtual target by the target-getting tool; and a result generating device that outputs the information about a player and information about the virtual targets that were spuriously gotten by the player read from the RF tag when the player brings the RF tag attached to the target-getting tool close to a RF reader/writer of the result generating device.

Further, according to a second aspect of the present invention, there is provided a virtual target getting game system, which includes: a target-getting tool to which a RF tag is attached; a main game machine in which RF reader/writers are mounted at positions of virtual targets to be gotten; a game controlling device that controls a RF reader/writer to read identifying information recorded in the RF tag and transmits the identifying information about the RF tag paired with information about a virtual target assigned to the reader/writer that reads the identifying information when a player brings the RF tag attached to the target-getting tool close to the RF reader/writer to spuriously get the virtual target by the target-getting tool; a database device that is connected with the game controlling device through a network and stores pairs of the identifying information about the RF tag and the information about the virtual target transmitted by the game controlling device; and a result generating device that outputs the identifying information about a player based on the identifying information about the RF tag read from the RF tag by a RF reader/writer mounted thereon and the information about the virtual targets that were spuriously gotten by the player retrieved from the database device based on the identifying information about the RF tag when the player brings the RF tag attached to the target-getting tool close to the RF reader/writer of the result generating device.

In either aspects described above, the result generating device preferably outputs the total score calculated based on the scores predetermined for the respective virtual targets. In addition, it is preferable that the virtual targets are explicitly displayed and/or a background thereof is displayed on the front surface of the main game machine that is looked by a player. On the back surface of the main game machine that cannot be looked by a player, the RF reader/writers are preferably mounted at the positions corresponding to the displayed positions of the virtual targets when the virtual targets are explicitly displayed or at any positions when the virtual targets are not displayed.

Still further, digital contents corresponding to the virtual targets that were spuriously gotten by the player may be shown on a displayed, printed or delivered to a player's communication terminal by the result generating device.

According to the virtual target getting game system of the present invention as constructed above, a player can spuriously get a virtual target through a getting action on the main game machine using the target-getting tool as in the case of a player getting a real target, and can confirm the virtual targets that were spuriously gotten through the use of the result generating device. Therefore, the game system can reduce the running cost because a managing side is not required preparing actual premiums and it can give a player sufficient realistic sensation because the system requires an actual action of a player as in the case of a player getting a real target.

### DESCRIPTION OF THE ACCOMPANYING DRAWINGS

FIG. 1 shows an outline of a game system according to a first embodiment of the present invention;

FIG. 2 is a block diagram showing an arrangement of the respective devices in the game system of the first embodiment;

FIG. 3 is a side view showing a main game machine in the game system of the first embodiment;

FIG. 4 is a front view of the main game machine shown in FIG. 3;

FIG. 5 is a front view of a target-getting tool in the game system of the first embodiment;

FIG. 6 is a side view showing the target-getting tool and the main game machine when a player spuriously gets a virtual target through the use of the target-getting tool;

FIG. 7 is a block diagram showing a construction of the game controlling device in the game system of the first embodiment;

FIG. 8 is a block diagram showing a construction of the result generating device in the game system of the first embodiment;

FIG. 9 shows one example of information recorded in a RF tag of the target-getting tool in the game system of the first embodiment;

FIG. 10 is a flowchart showing a basic flow of the game in the game system of the first embodiment;

FIG. 11 is a flowchart showing a process at step S104 in FIG. 10 in detail;

FIG. 12 is a block diagram showing an arrangement of devices in a game system of a second embodiment;

FIG. 13 is a block diagram showing the game controlling device and the database device in the game system of the second embodiment;

FIG. 14 is a block diagram showing a result generating device in the game system of the second embodiment;

FIG. 15 shows one example of information recorded in the database device in the game system of the second embodiment; and

FIG. 16 is a flowchart showing a basic flow of the game in the game system of the second embodiment.

### DESCRIPTION OF THE PREFERRED EMBODIMENTS

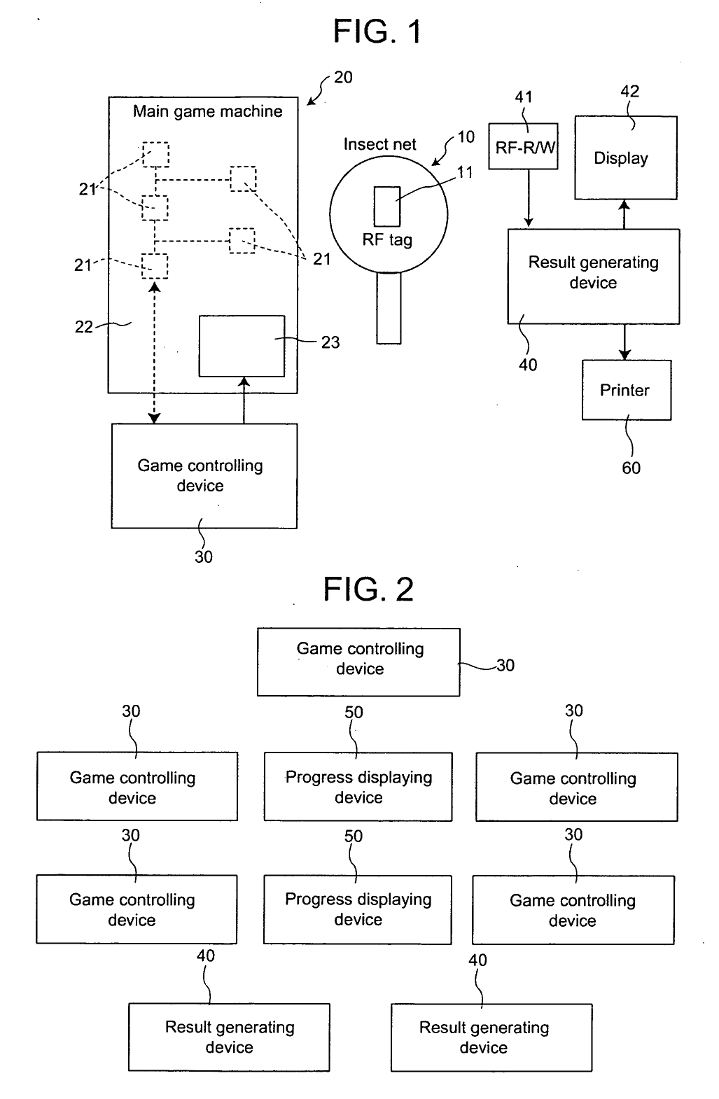

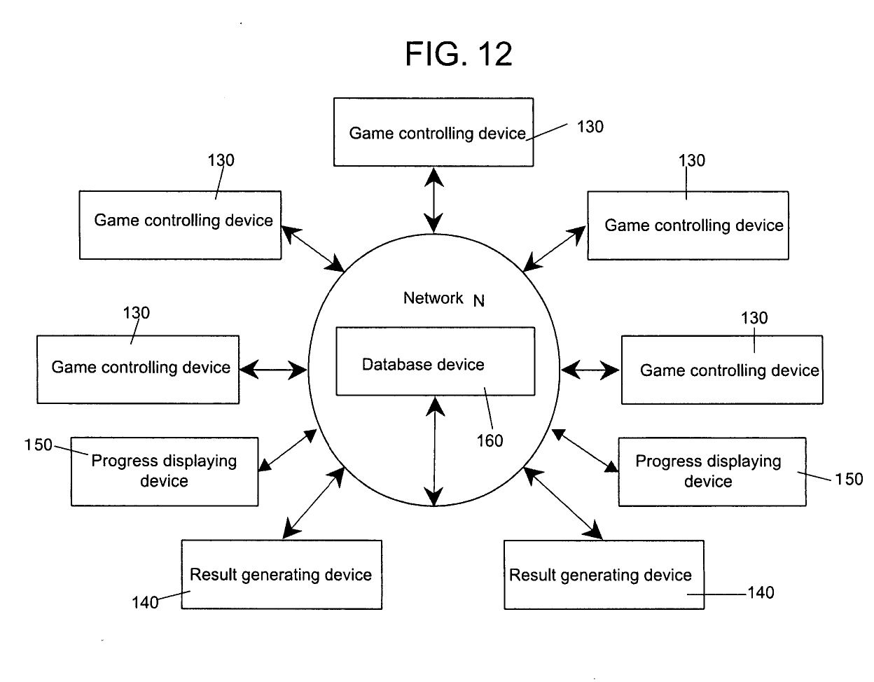

Hereinafter, a virtual target getting game system according to the present invention will be described based on two embodiments. FIGS. 1 through 11 show the first embodiment and FIGS. 12 through 16 show the second embodiment. In the first and second embodiments, the present invention is applied to an insect-collecting game.

### First Embodiment

To begin with, a summary of a game system of the first embodiment will be described based on FIG. 1 and FIG. 2. The game system of the first embodiment is provided with an insect net 10 as a target-getting tool to which RF (Radio Frequency) tag 11 is attached at the tip end thereof, a main game machine 20 in which a plurality of RF reader/writers 21 are mounted at positions of virtual insects as virtual targets to be gotten, a game controlling device 30 that controls the RF reader/writers 21 to record information about insects that were spuriously gotten by a player into the RF tag 11, a result generating device 40 that reads the information about a player and information about the virtual insects that were spuriously gotten by the player from the RF tag 11 of the insect net 10 by a RF reader/writer 41 and that outputs the information to a display 42 and a printer 60 or the like, and a progress displaying device 50 that displays information about insects on a display 52 based on the information read from the RF tag 11 by a RF reader/writer 51.

Further, the result generating device 40 has a function of a reception unit that records identifying information about a player into the RF tag 11 when the information is inputted at the start of the game, and it has a function to output the total score calculated based on the scores predetermined for the respective insects.

The game controlling devices 30 are located at a plurality of points so that each game controlling device 30 is paired with the main game machine 20 as shown in FIG. 2. Further, the result generating devices 40 and the progress displaying devices 50 are arranged at a plurality of points as needed. The main game machine 20 (and the game controlling device 30) is arranged corresponding to the field of insect collecting. The arrangement of a plurality of main game machines 20 can provide players with a plurality of fields having different environments such as a broad leaf forest in which beetles and stag beetles live, a grassy plain in which grasshoppers and mantises live, a flower field in which butterflies and bees live, or the like. In the first embodiment, since the RF tag 11 stores both of the identifying information about a player and the identifying information about insects that were spuriously gotten, the game controlling devices 30, the result generating devices 40 and the progress displaying devices 50 are arranged on a stand alone basis without being connected one another.

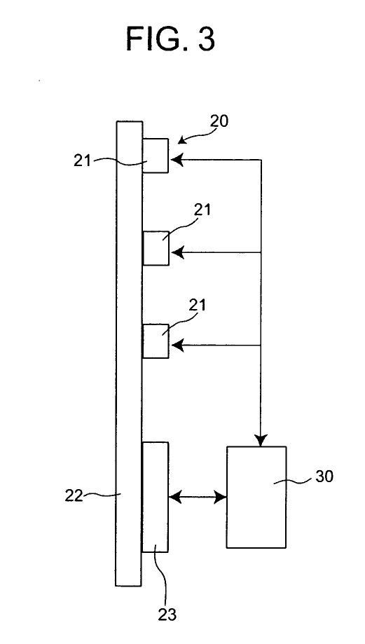

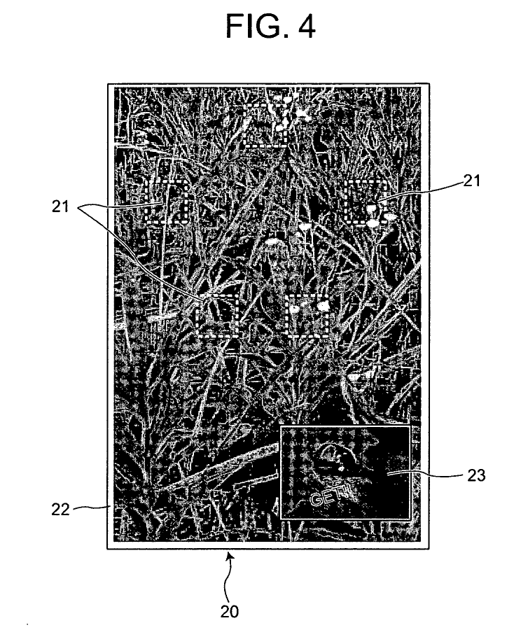

The main game machine 20 is provided with a display board 22 into which a display 23 is fitted as shown in FIG. 3. Information output from the game controlling device 30 appears on the display 23. As shown in FIG. 4, a photograph of a background (a grassy plain, in this example) of a field where insects as targets to be gotten usually live is pasted on the front surface of the display board 22 that is looked by a player. On the back surface of the display board that cannot be looked by a player, the RF reader/writers 21 are attached.

The RE reader/writers 21 are assigned to the respective insects. When a player brings the RF tag 11 attached to the insect net 10 close to any RF reader/writer 21, the game controlling device 30 controls the close RF reader/writer 21 to record information about an insect assigned to the close RF reader/writer 21 into the RF tag 11. That is, the position of the RF reader/writer 21 attached on the back surface means the position of the virtual insect. In this embodiment, the positions of the RF reader/writers 21 are marked by broken lines on the front surface of the display board 22. These marks may not be displayed. Further, pictures or photographs of insects may be pasted in place of the marks to explicitly display the target to be gotten.

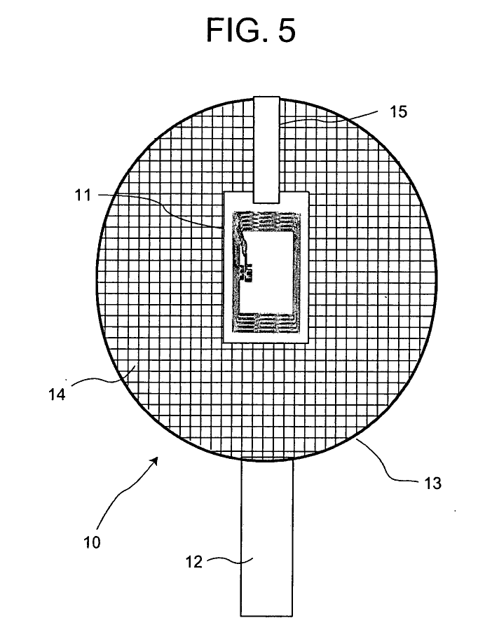

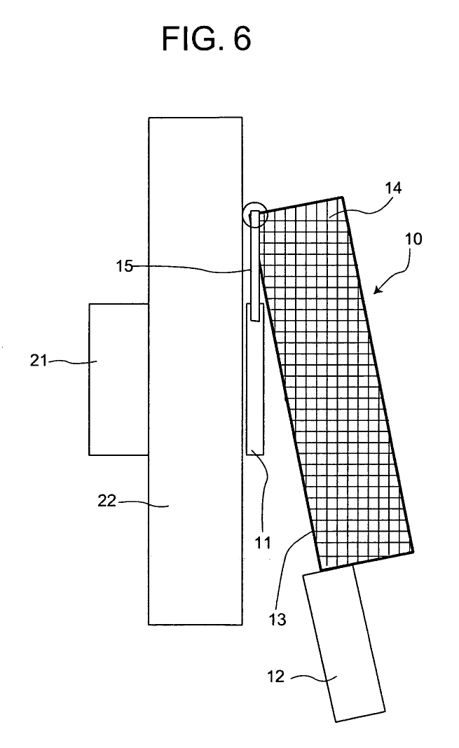

The insect net 10 consists of a rod-shaped handle 12, a ring-shaped frame 13 attached to the tip of the handle 12, and a net bag 14 pitched on the frame 13 as shown in the front view in FIG. 5. The RF tag 11 is hung from the upper edge of the frame 13 through a belt 15. When a player spuriously gets the virtual insect, the player holds the insect net 10 so that the frame 13 contacts with the front surface of the display board 22 of the main game machine 20, and then the player pulls the handle 12 toward him or her to tilt the insect net 10 as shown in FIG. 6. This brings the RF tag 11 close to the front surface of the display board 22. If the RF reader/writer 21 is located at the point to which the RF tag 11 closes on the back surface of the display panel 22, this RF reader/writer 21 records the information about insect assigned to this RF reader/writer 21 into the RF tag 11.

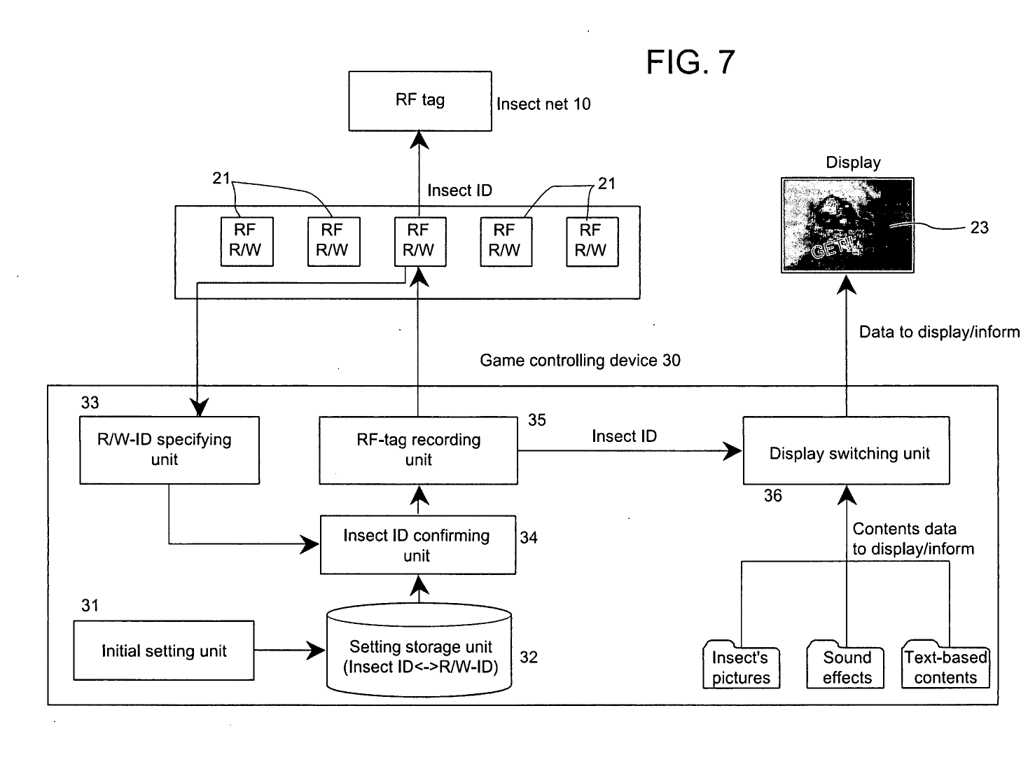

The game controlling device 30 includes, as shown in FIG. 7, an initial setting unit 31 that assigns identifying information about insect (insect ID) to identifying information about the RE reader/writer 21 (R/W-ID) mounted on the main game machine 20 connected thereto, a setting storage unit 32 that stores the combination information (pair of the insect ID and the R/W-ID) set by the initial setting unit 31, a R/W-ID specifying unit 33 that is connected to the RF reader/writers 21 and specifies the identifying information (R/W-ID) of the RF reader/writer 21 that detects the RF tag 11 when the RF tag 11 closes to the RF reader/writer 21, an insect ID confirming unit 34 that searches the setting storage unit 32 to confirm the insect ID corresponding to the specified R/W-ID, and a RF-tag recording unit 35 that controls the RF reader/writer 21 to record the confirmed insect ID into the RF tag 11.

In addition, the game controlling device 30 is provided with a display switching unit 36 that makes the display 23 of the main game machine 20 show a successful getting based on the insect ID output from the RF-tag recording unit 35. The display switching unit 36 contains files of insect's pictures to be shown on the display, file of sound effects and files of text-based contents, and it reads the corresponding insect's picture, sound effect and text-based contents based on the insect ID to reproduce them.

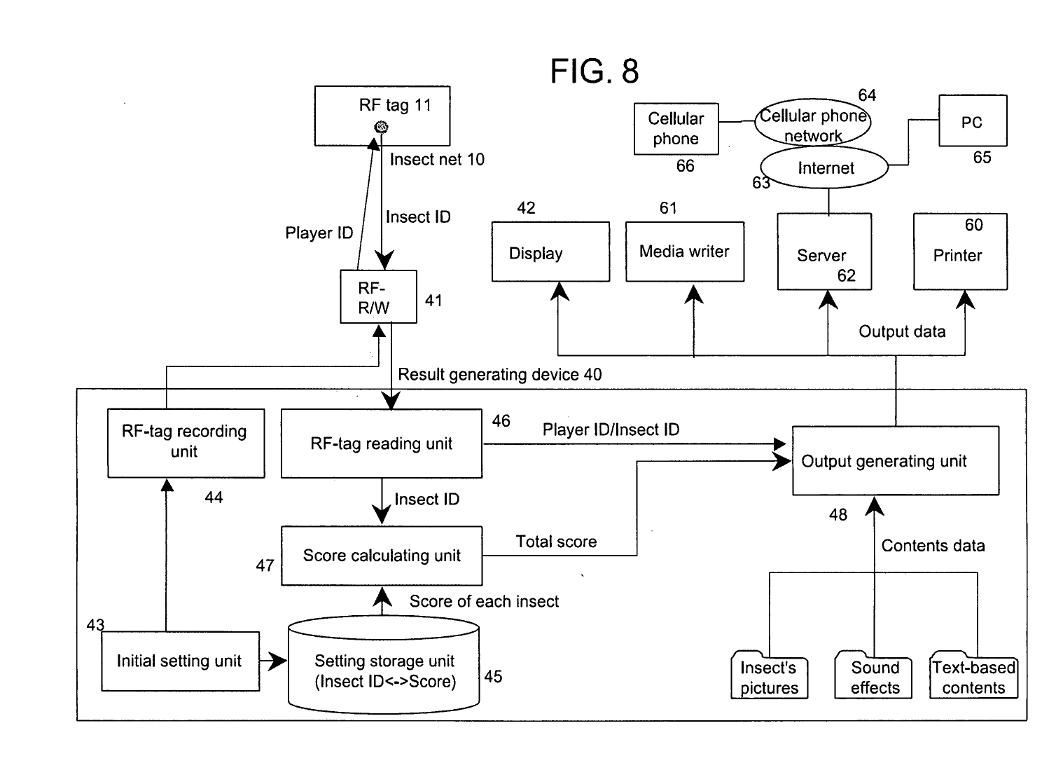

The result generating device 40 includes, as shown in FIG. 8, an initial setting unit 43 that enters the identifying information about a player (a player ID) at the time of reception of the insect collecting and assigns scores to the insect ID's, a RF-tag recording unit 44 that records the player ID set by the initial setting unit 43 at the time of reception into the RF tag 11 through the RF reader/writer 41, a setting storage unit 45 that stores the combination information (pair of the insect ID and the score) set by the initial setting unit 43, a RF-tag reading unit 46 that reads the information (the player ID, the insect ID) recorded in the RF tag 11 through the RF reader/writer 41 after the insect collecting, and a score calculating unit 47 that reads scores assigned to the respective insects from the setting storage unit 45 based on the read insect ID to calculate the total score. The score assigned to each of the insects is determined in consideration of a rarity value of the insect and difficulty to actually get the insect, for example. Higher score is applied to an insect that is rarer and more difficult to get.

Further, the result generating device 40 is provided with an output generating unit 48 that outputs the data to the display 42, the printer 60 or the like based on the player ID and the insect ID read by the RF-tag reading unit 46, and the total score calculated by the score calculating unit 47. The output generating unit 48 contains files of insect's pictures, file of sound effects and files of text-based contents that are included in the output result, and it reads the corresponding insect's picture, sound effect and text-based contents based on the insect ID to display and reproduce them. At the time of output, a certificate that includes the data of the player entered at the time of reception, the pictures of the insects that were spuriously gotten and the total score is shown on the display 42. The certificate is printed by the printer 60 and is delivered to the player as needed. Further, the image data of the certificate may be converted into a file of the HTML format. The HTML file of the certificate can be recorded into a memory card of a player's communication terminal or a player's cellular phone by a media writer 61. Alternatively, the HTML file of the certificate may be transmitted to the server 62 to deliver it to the player's mail address through the Internet 63 or a cellular phone network 64. The player can receive the certificate by a personal computer (PC) 65 or a cellular phone 66 to display and/or to print it.

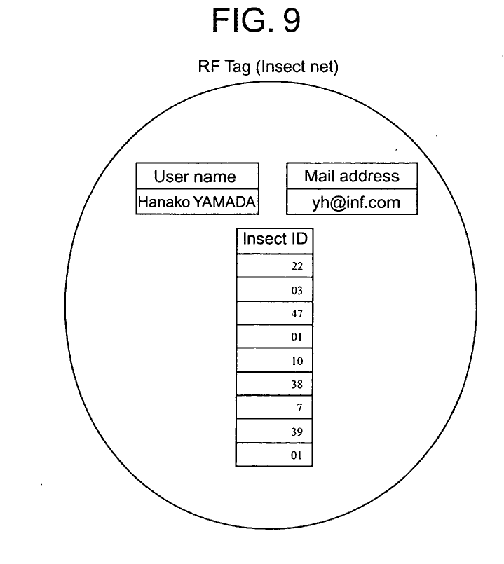

FIG. 9 shows one example of information recorded in the RF tag 11 after the insect collecting. That is, the player's name “Hanako YAMADA” and her mail address “yh@mif.com” are recorded as the player's information, and the gotten insect ID “22, 03, 47, 01, 10, 38, 07, 39, 01” are recorded.

The progress displaying device 50 is constructed by simplifying the result generating device 40. While the detail is not shown in the drawing, the progress displaying device 50 has a function to show the pictures of the insects corresponding to the insect ID's read by a RF reader/writer from the RF tag 11 on an display.

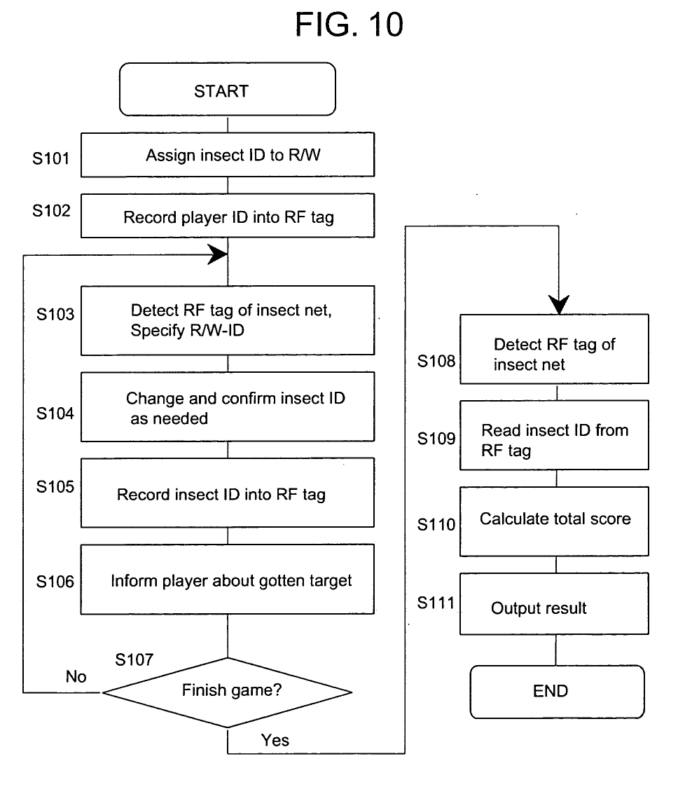

Next, the basic flow of the game in the game system of the first embodiment constructed as above will be described based on the flowchart in FIG. 10.

First, an insect ID is assigned to each RF reader/writer 21 through the use of the initial setting device 31 for each game controlling device 30 (S101).

When a player starts the game, the insect net 10 is handed to the player and player's information is recorded into the RF tag 11 by the initial setting device 43 of the result generating device 40 (S102). After finishing the registration of the player, the player makes the rounds of the fields to spuriously get the virtual insects. When the player stands in front of the main game machine 20 and covers the mark on the display board 22 by the insect net 10 so that the RF tag 11 corresponds to the mark, the RF reader/writer 21 attached to the back surface of the display board 22 corresponding to the mark in question detects the RF tag 11 and transmits its identifying information (R/W-ID) to the R/W-ID specifying unit 33 (S103).

The insect ID confirming unit 34 in the game controlling device 30 confirms the insect ID by the R/W-ID based on the information stored in the setting storage unit 32 (S104). In addition, the insect ID confirming unit 34 changes the combination between the R/W-ID and the insect ID set by the initial setting unit 31 for a combination that is previously registered at the predetermined time. Moreover, the combination is randomly changed with using random numbers at the specific time.

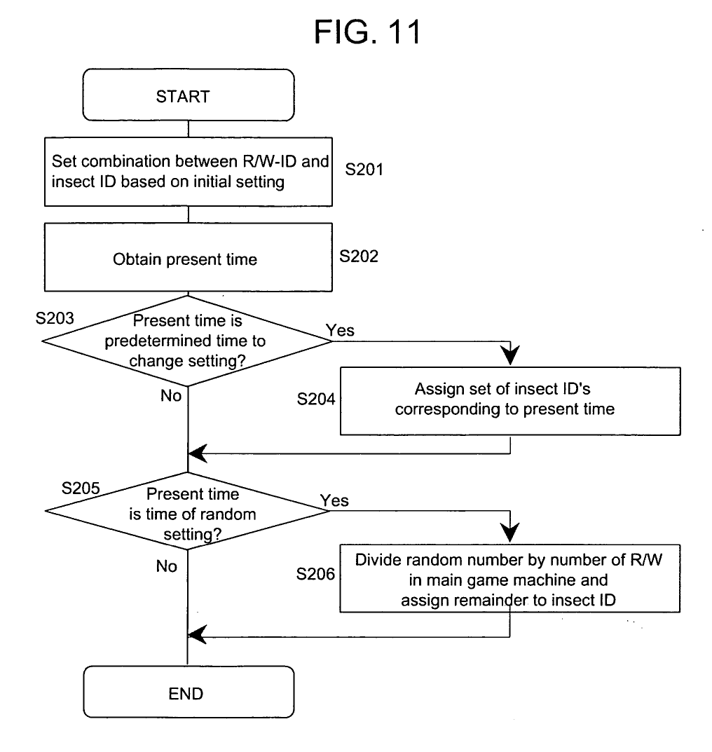

Hereby, the process for changing the combination between the R/W-ID and the insect ID executed at S104 will be described in detail based on the flowchart in FIG. 11. First, the insect ID confirming unit 34 sets the combination set by the initial setting unit 31 as an initial value (S201) Then, the insect ID confirming unit 34 obtains the present time (S202) and checks whether the present time is coincident with the predetermined time to change the setting or not (S203). If the present time is the time to change the setting, a set of the insect ID's corresponding to the time is assigned (S204). Next, the insect ID confirming unit 34 checks whether the present time is coincident with the time of random setting or not (S205). If the present time is the time of random setting, the insect ID confirming unit 34 generates a random number for each R/W-ID, divides the random number by the number of the RE reader/writers 21 included in the main game machine 20 and assigns the remainder to the insect ID corresponding to the RF reader/writer 21 (S206). Since the combination between the R/W-ID and the insect ID is changed in this way, the correspondence between the mark and the insect changes successively, which allows a player who has played in past to replay with a sense of tension.

Back to the description of FIG. 10, when the insect ID has been confirmed in the process at S104, the RF-tag recording unit 35 in the game controlling device 30 records the confirmed insect ID into the RF tag 11 by the RF reader/writer 21 (S105). Then, the display switching unit 36 shows the picture of insect that was gotten with the text-based contents “GET!!” superimposed on the picture on the display 23 of the main game machine 20 to inform the player about the insect that was gotten (S106) and reproduces the sound effect with a loudspeaker (not shown) Next, the main game machine 20 judges whether the player finishes the game or not (S107). If the game is finished, the process at S108 and the following steps will be executed. If the game is not finished, the processes from S103 to S106 are repeated for each field (for each main game machine 20). In normal procedure, a player finishes the game after he or she made the rounds of all the fields and got one insect per field.

To finish the game, a player brings the insect net 10 to the result generating device 40 and closes the RF tag 11 to the RF reader/writer 41. The RF reader/writer 41 detects the RF tag 11 (S108), and the RF-tag reading unit 46 in the result generating device 40 reads the insect ID's and the player ID recorded in the RF tag 11 (S109). Then, the score calculating unit 47 calculates the total score based on the insect ID's read from the RF tag 11 (S110). Further, the output generating unit 48 shows the certificate with using the insect ID's, the player ID and the total score on the display 42. If necessary, the output generating unit 48 prints the certificate by the printer 60, records the HTML file into the memory through the media writer 61 or delivers the HTML file to the network through the server 62 (S111).

As described above, according to the game system of the first embodiment, a virtual target getting game such as a virtual insect collecting can be realized through the use of a RF tag that has been used for merchandise management in distributive trade. Further, since the full information including the insect ID's that were spuriously gotten by the player are recorded into the RF tag, it is unnecessary to connect the game controlling device 30 and the result generating device 40 to the network, which realizes the system at low cost. Furthermore, since the information is distributed and is not centralized, the strength of the system can be kept at high level.

### Second Embodiment

Next, a game system of the second embodiment will be described. The game system of the first embodiment is a distributed system where the player's information and the insect ID are recorded into the RF tag. On the other hand, the game system of the second embodiment is a centralized system where the RF tag stores only identifying information about itself and the database device stores identifying information about insects that were spuriously gotten linked with the player's identifying information. The constructions of the insect net 10 and the main game machine 20 are common to the first embodiment.

The entire construction of the system is shown in FIG. 12. A plurality of game controlling devices 130 are arranged as paired with the main game devices 20, respectively, as shown in FIG. 12. There are result generating devices 140 and progress displaying devices 150 in the system. The respective devices are connected to a database device 160 through a network N.

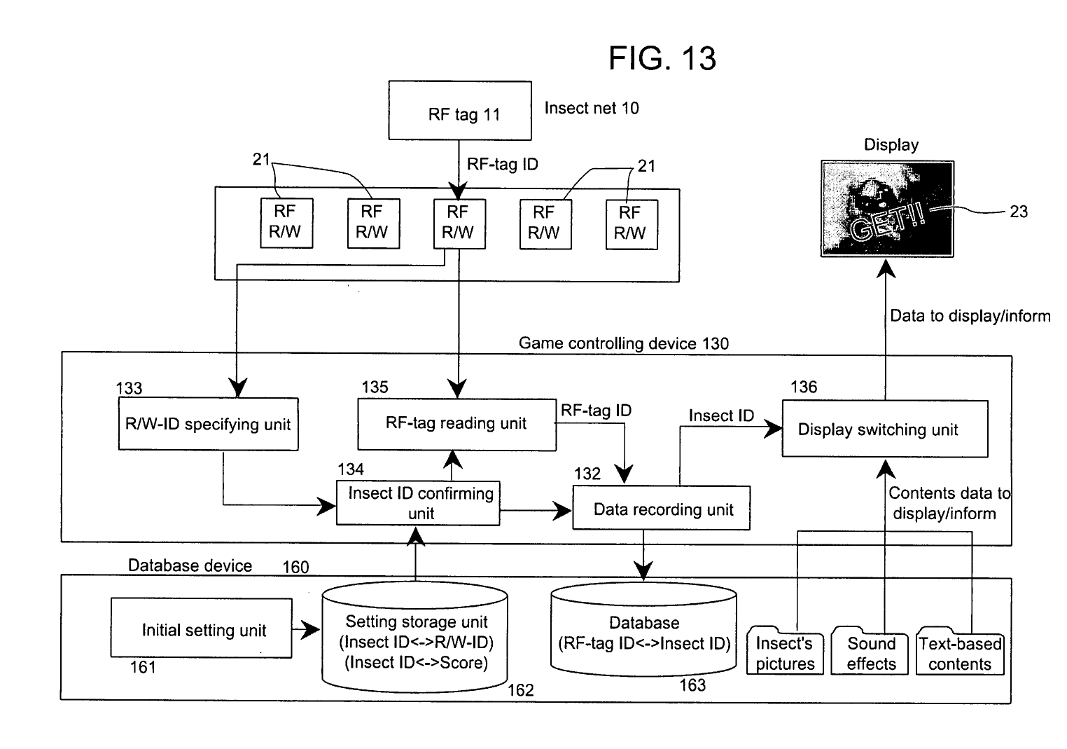

The database device 160 is provided with, as shown in FIG. 13, an initial setting unit 161 that assigns the identifying information about insects (insects ID's) to the respective RF reader/writers 21 mounted on all the main game machines 20 in the system and assigns scores to the insect ID's, a setting storage unit 162 that stores the combination information (pair of the insect ID and RW-ID, and pair of the insect ID and the score) set by the initial setting unit 161, a database 163 that stores identifying information about the RF tag (RF-tag ID) attached to the insect net 10 held by a player with the insect ID's of the insects that were spuriously gotten with using the insect net 10. The database device 160 contains files of insect's pictures to be shown on the display, file of sound effects and files of text-based contents.

On the other hand, the game controlling device 30 includes a R/W-ID specifying unit 133 that is connected to the RF reader/writers 21 mounted on the main game machine 20 and specifies the identifying information (R/W-ID) of the RF reader/writer 21 that detects the RF tag 11 when the RF tag 11 closes to the RF reader/writer 21, a RF-tag reading unit 135 that reads the identifying information about the RF tag 11 (RF-tag ID), an insect ID confirming unit 134 that searches the setting storage unit 162 of the database device 160 to confirm the insect ID corresponding to the specified R/W-ID, and a data recording unit 132 that records the confirmed insect ID linked with the RF-tag ID into the database 163.

Further, the game controlling device 130 is provided with a display switching unit 136 that makes the display 23 of the main game machine 20 show a successful getting based on the insect ID output from the data recording unit 132. The display switching unit 136 reads the corresponding insect's picture, sound effect and text-based contents from the database device 160 based on the insect ID to show and reproduce them.

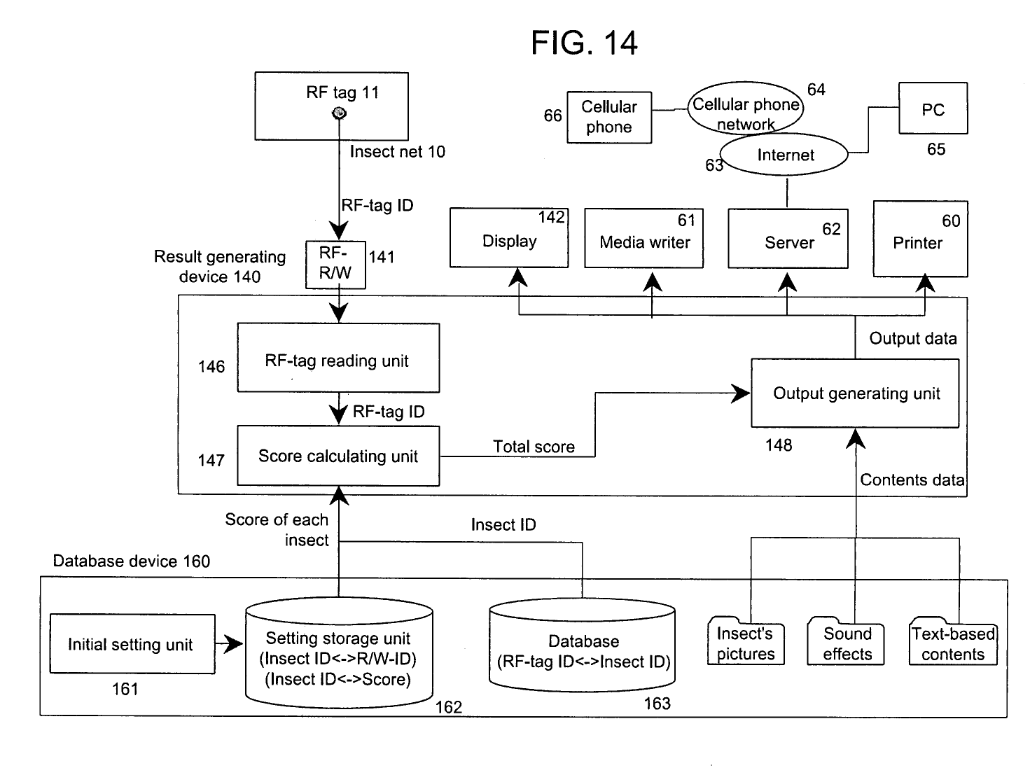

The result generating device 140 includes, as shown in FIG. 14, a RF-tag reading unit 146 that reads the RF-tag ID from the RF tag 11 through the RF reader/writer 41, and a score calculating unit 147 that searches the database 163 based on the read RF-tag ID for the insect ID corresponding to the RF-tag ID, and searches the setting storage unit 162 based on the read insect ID for the scores assigned to the respective insects to calculate the total score. In addition, the result generating device 140 has a function to read the RF-tag ID of the RF tag 11 attached to the insect net 10 that is handed to a player at the time of the reception of the insect collecting. The RF-tag ID read from the RF tag 11 is linked to the player's identifying information (player ID) read from the initial setting unit 161 of the database device 160 and is stored into the setting storage unit 162.

Further, the result generating device 140 is provided with an output generating unit 148 that outputs the data to the display 142, the printer 60 or the like based on the player ID that is extracted from the setting storage unit 162 based on the RF-tag ID read by the RF-tag reading unit 146, the insect ID extracted from the database 163 and read by the RF-tag reading unit 46, and the total score calculated by the score calculating unit 147. The output generating unit 148 reads the corresponding insect's picture, sound effect and text-based contents based on the insect ID from the database device 160 to display and reproduce them. At the time of output, a certificate that includes the data of the player entered at the time of reception, the pictures of the insects that were spuriously gotten during the game and the total score is shown on the display 142. The certificate is printed by the printer 60 and is delivered to the player as needed. Further, the image data of the certificate may be converted into a file of the HTML format. The HTML file of the certificate can be recorded into a memory card of a player's communication terminal or a player's cellular phone by a media writer 61. Alternatively, the HTML file of the certificate may be transmitted to the server 62 to deliver it to the player's mail address through the Internet 63 or a cellular phone network 64.

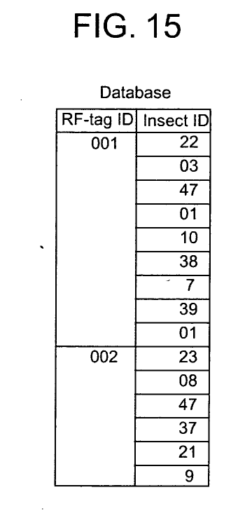

FIG. 15 shows one example of information recorded in the database 163 after the insect collecting. That is, the insect ID's of the insects that were spuriously gotten with using the insect net 10 are stored with the RF-tag ID of the RF tag attached to the insect net 10 as an index. In addition, the setting storage unit 162 stores name and mail address of a player as the player's information in relation to the RF-tag ID. Therefore, the system can know which player spuriously got which virtual insects by referring to the setting storage unit 162.

The progress displaying device 150 is constructed by simplifying the result generating device 140. While the detail is not shown in the drawing, the progress displaying device 150 has a function to read the insect ID's from the database 163 based on the RF-tag ID read by the RF reader/writer and show the pictures of the insects corresponding to the read insect ID's on an display.

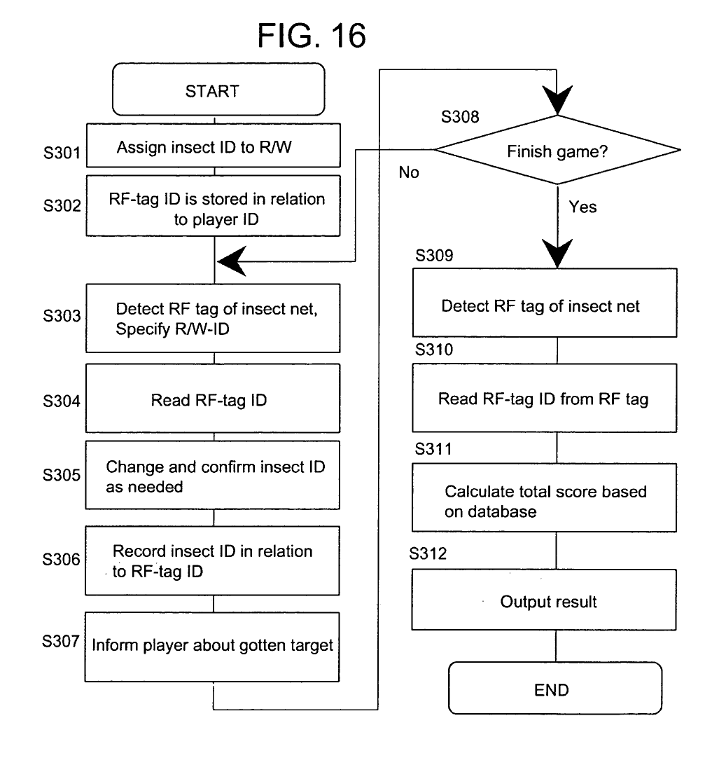

Next, the basic flow of the game in the game system of the second embodiment constructed as above will be described based on the flowchart in FIG. 16.

First, an insect ID is assigned to each RF reader/writer 21 through the use of the initial setting device 161 for each game controlling device 30 (S301).

When a player starts the game, the insect net 10 is handed to the player and the RF-tag ID is read by the result generating device 140. The RF-tag ID is stored into the initial setting device 162 in relation to the player's information entered by the initial setting unit 161 (S302). After finishing the registration of the player, the player makes the rounds of the fields to spuriously get the virtual insects. When the player stands in front of the main game machine 20 and covers the mark on the display board 22 by the insect net 10 so that the RF tag 11 corresponds to the mark, the RF reader/writer 21 attached to the back surface of the display board 22 corresponding to the mark in question detects the RF tag 11 and transmits its identifying information (R/W-ID) to the R/W-ID specifying unit 133 (S303). At the same time, the RF-tag reading unit 135 reads the RF-tag ID (S304).

The insect ID confirming unit 134 in the game controlling device 30 confirms the insect ID by the R/W-ID based on the information stored in the setting storage unit 162 (S305). The insect ID confirming unit 134 can change the combination between the R/W-ID and the insect ID in the same manner as the first embodiment.

When the insect ID has been confirmed in the process at S305, the data recording unit 132 in the game controlling device 30 records the confirmed insect ID into the database 163 in relation to the RF-tag ID (S306). After receiving the insect ID, the display switching unit 136 shows the picture of insect that was gotten with the text-based contents “GET!!” superimposed on the picture on the display 23 of the main game machine 20 to inform the player about the insect that was gotten (S307) and reproduces the sound effect with a loudspeaker (not shown).

Next, the main game machine 20 judges whether the player finishes the game or not (S308). If the game is finished, the process at S309 and the following steps will be executed. If the game is not finished, the processes from S303 to S307 are repeated for each field (for each main game machine 20). In normal procedure, a player finishes the game after he or she made the rounds of all the fields and got one insect per field.

To finish the game, a player brings the insect net 10 to the result generating device 140 and closes the RF tag 11 to the RF reader/writer 141. The RF reader/writer 141 detects the RF tag 11 (S309), and the RF-tag reading unit 146 in the result generating device 140 reads the RF-tag ID (S310). Then, the score calculating unit 147 calculates the total score based on the insect ID's (S311). Further, the output generating unit 148 shows the certificate with using the insect ID's, the player ID and the total score on the display 142. If necessary, the output generating unit 148 prints the certificate by the printer 60, records the HTML file into the memory through the media writer 61 or delivers the HTML file to the network through the server 62 (S312).

As described above, according to the game system of the second embodiment, since all the game controlling devices 30 and the result generating devices 40 are connected through the network, the initial data can be set at one point without setting the initial data at the respective devices as the first embodiment. Further, since the information about the respective players can be managed collectively, additional work, such as a ranking in the order of the score, can be done without any difficulty.

1. A virtual target getting game system, comprising:
a target-getting tool to which a RF tag is attached;
a main game machine in which RF reader/writers are mounted at positions of virtual targets to be gotten;
a game controlling device that controls a RF reader/writer to record information about a virtual target assigned thereto into a RF tag when a player brings said RF tag attached to said target-getting tool close to said RF reader/writer to spuriously get said virtual target by said target-getting tool; and
a result generating device that outputs the information about a player and information about said virtual targets that were spuriously gotten by said player read from said RF tag when said player brings said RF tag attached to said target-getting tool close to a RF reader/writer of said result generating device.

2. A virtual target getting game system, comprising:
a target-getting tool to which a RF tag is attached;
a main game machine in which RF reader/writers are mounted at positions of virtual targets to be gotten;
a game controlling device that controls a RF reader/writer to read identifying information recorded in said RF tag and transmits the identifying information about said RF tag paired with information about a virtual target assigned to said RF reader/writer that reads the identifying information when a player brings said RF tag attached to said target-getting tool close to said RF reader/writer to spuriously get said virtual target by said target-getting tool;
a database device that is connected with said game controlling device through a network and stores pairs of the identifying information about said RF tag and the information about said virtual target transmitted by said game controlling device; and
a result generating device that outputs the identifying information about a player based on the identifying information about said RF tag read from said RF tag by a RF reader/writer mounted thereon and the information about said virtual targets that were spuriously gotten by said player retrieved from said database device based on the identifying information about said RF tag when said player brings said RF tag attached to said target getting tool close to a RF reader/writer of said result generating device.

3. The virtual target getting game system according to claim 1 or 2, wherein said result generating device outputs the total score calculated based on the scores predetermined for the respective virtual targets.

4. The virtual target getting game system according to claim 1 or 2, wherein said virtual targets are explicitly displayed on the front surface of said main game machine that is looked by a player, and wherein said RF reader/writers are mounted at the positions corresponding to the displayed positions of said virtual targets on the back surface of said main game machine that cannot be looked by a player.

5. The virtual target getting game system according to claim 4, wherein a background of said virtual targets is displayed in addition to said virtual targets on the front surface.

6. The virtual target getting game system according to claim 1 or 2, wherein a background of said virtual targets is displayed on the front surface of said main game machine that is looked by a player, and wherein said RF reader/writers are mounted at any positions on the back surface of said main game machine that cannot be looked by a player.

7. The virtual target getting game system according to claim 1 or 2, wherein said result generating device shows digital contents corresponding to said virtual targets that were spuriously gotten by said player on a display.

8. The virtual target getting game system according to claim 1 or 2, wherein said result generating device prints digital contents corresponding to said virtual targets that were spuriously gotten by said player.

9. The virtual target getting game system according to claim 1 or 2, wherein said result generating device delivers digital contents corresponding to said virtual targets that were spuriously gotten by said player to a player's communication terminal.
